(19) United States
(12) Patent Application Publication
(10) Pub. No.: US 2010/0149396 A1
(43) Pub. Date: Jun. 17, 2010

(54) IMAGE SENSOR WITH INLAID COLOR PIXELS IN ETCHED PANCHROMATIC ARRAY

(76) Inventors: Joseph R. Summa, Hilton, NY (US); Christopher Parks, Rochester, NY (US); John P. McCarten, Penfield, NY (US)

Correspondence Address: Pedro P. Hernandez;Patent Legal Staff, Eastman Kodak Company, 343 State Street, Rochester, NY, 14650-2201, US

(21) Appl. No.: 12/567,833

(22) Filed: Sep. 28, 2009

Related U.S. Application Data
(60) Provisional application No. 61/122,879, filed on Dec. 16, 2008.

(51) Int. Cl. H04N 5/335

(52) U.S. Cl. 348/311; 348/E05.091

(57) ABSTRACT

An image sensor includes a substrate with a plurality of photosensitive elements. A transparent inorganic layer is situated over the substrate, and a plurality of openings is formed in the transparent inorganic layer. A color filter array has a plurality of panchromatic filter elements that are formed by the transparent inorganic layer, and a plurality of color filter elements are situated in the openings. The panchromatic filter elements and the color filter elements each include top surfaces that are essentially planar with the top surface of the transparent inorganic layer.

### CROSS REFERENCE TO RELATED APPLICATION

This application claims the benefit of U.S. Provisional Application No. 61/122,879 filed on Dec. 16, 2008, which is incorporated herein by reference.

### TECHNICAL FIELD

The invention relates generally to the field of image sensors, and more particularly to color filter arrays for image sensors.

### BACKGROUND

A typical image sensor has an image sensing portion that includes a photosensitive area or charge collection area for collecting a charge in response to incident light. Examples of such electronic image sensors include charge coupled device (CCD) image sensors and active pixel sensor (APS) devices (APS devices are often referred to as CMOS sensors because of the ability to fabricate them in a Complementary Metal Oxide Semiconductor process). Typically, these images sensors include a number of light sensitive pixels, often arranged in a regular pattern of rows and columns. Each pixel includes a photosensor, such as a photodiode, that produces a signal corresponding to the intensity of light impinging on that pixel when an image is focused on the array. The magnitude of the signal produced by each pixel, therefore, is proportional to the amount of light impinging on the photosensor.

For capturing color images, a color filter array (CFA) is typically fabricated on the pattern of pixels, with different filter materials being used to make individual pixels sensitive to only a portion of the visible light spectrum. The color filters necessarily reduce the amount of light reaching each pixel, and thereby reduce the light sensitivity of each pixel.

In an effort to increase the number of pixels provided in an image sensor, pixel size has been decreasing. However, as the pixel size shrinks, the illuminated area of the photodetector is also typically reduced, in turn further decreasing the captured signal level and degrading performance. Moreover, as pixel sizes continue to decrease, there is a need to maintain quantum efficiency and angle response while minimizing cross talk. The incorporation of panchromatic elements into the color filter pattern has been shown to dramatically increase sensitivity.

The panchromatic elements of some of these color filter arrays are produced, for example, using a clear organic filler layers (photoresist, polyimide, or acrylates for example)—that are typically photosensitive and defined in a pattern similar to the color elements. Incorporation of a clear layer increases process complexity and produces pan pixels with sloped sidewalls. Some known processes produce panchromatic pixels by simply leaving the top passivation layer exposed without any additional material added at the level occupied by color filters in neighboring pixels. Although this has the advantage of reducing processing steps, the resulting lack of planarity is not conducive to microlens patterning.

The use of an etch process to define a template to be filled by color filters has been proposed. Template features with extremely high resolution, alignment precision, and pattern fidelity can formed in this manner through the use of conventional high resolution lithographic and etch equipment commonly used in integrated circuit manufacturing. Reactive ion etching, for example, can be used to create extremely narrow trenches with nearly vertical sidewalls. Although such templates allow improved placement and dimensional control of the color filters, it is constructed as a frame around each pixel element and so reduces the area of the pixel that can be occupied by the color filter. This will reduce efficiency and increase cross-talk as pixel size continues to decrease.

A need thus persists for improved image sensors that employ CFAs with both color and panchromatic filter elements.

### SUMMARY

An image sensor includes a substrate with a plurality of photosensitive elements. A transparent inorganic layer is situated over the substrate, and a plurality of openings is formed in the transparent inorganic layer. A color filter array has a plurality of panchromatic filter elements that are formed by the transparent inorganic layer, and a plurality of color filter elements are situated in the openings. The panchromatic filter elements and the color filter elements each include top surfaces that are essentially planar with the top surface of the transparent inorganic layer.

### ADVANTAGEOUS EFFECT

The present invention improves the quantum efficiency and the angular quantum efficiency in image sensors. The present invention also increases the sensitivity of image sensors.

### BRIEF DESCRIPTION OF THE DRAWINGS

Embodiments of the invention are better understood with reference to the following drawings. The elements of the drawings are not necessarily to scale relative to each other.

FIG. 1 is a block diagram illustrating an embodiment of an image capture device.

FIG. 2 is a block diagram conceptually illustrating portions of a pixel.

FIG. 3 illustrates an example of a color filter array pattern.

FIGS. 4A-4D illustrate examples of a color filter array patterns including both color filter elements and panchromatic filter elements.

FIG. 5 is a side sectional view conceptually illustrating portions of an image sensor.

FIG. 6 is a side sectional view conceptually illustrating portions of an image sensor in accordance with embodiments of the present disclosure.

FIGS. 7A-7D are side sectional views conceptually illustrating portions of the image sensor illustrated in FIG. 6.

FIGS. 8A-8B are side sectional views conceptually illustrating portions of an image sensor in accordance with embodiments of the present disclosure.

FIGS. 9A-9D are side sectional views conceptually illustrating portions of an image sensor in accordance with embodiments of the present disclosure.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

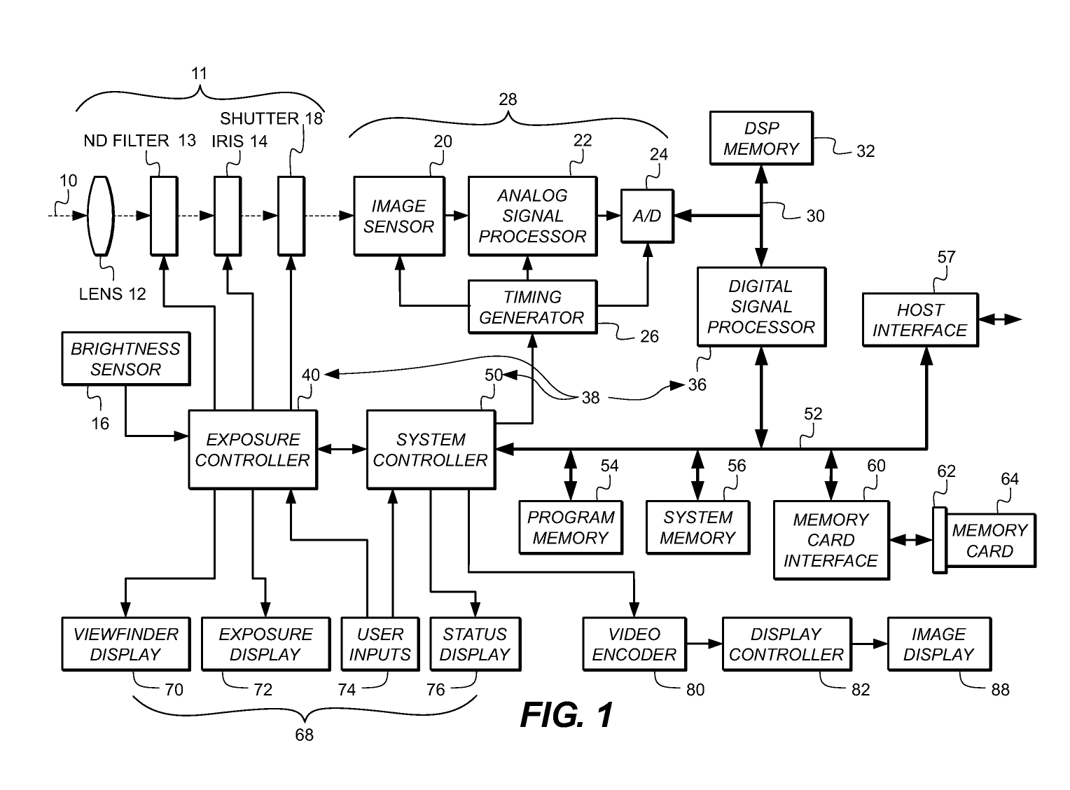

Turning now to FIG. 1, a block diagram of an image capture device shown as a digital camera embodying aspects of the present disclosure is illustrated. Although a digital camera is illustrated and described, the present invention is clearly applicable to other types of image capture devices. In the disclosed camera, light 10 from a subject scene is input to an imaging stage 11, where the light is focused by a lens 12 to form an image on an image sensor 20. The image sensor 20 converts the incident light to an electrical signal for each picture element (pixel).

The amount of light reaching the sensor 20 is regulated by an iris block 14 that varies the aperture and the neutral density (ND) filter block 13 that includes one or more ND filters interposed in the optical path. Also regulating the overall light level is the time that the shutter block 18 is open. The exposure controller block 40 responds to the amount of light available in the scene as metered by the brightness sensor block 16 and controls all three of these regulating functions.

This description of a particular camera configuration will be familiar to one skilled in the art, and it will be apparent to such a skilled person that many variations and additional features are present. For example, an autofocus system is added, or the lens is detachable and interchangeable. It will be understood that the present disclosure applies to various types of digital cameras where similar functionality is provided by alternative components. For example, the digital camera is a relatively simple point and shoot digital camera, where the shutter 18 is a relatively simple movable blade shutter, or the like, instead of the more complicated focal plane arrangement. Aspects of the present invention can also be practiced on imaging components included in non-camera devices such as mobile phones and automotive vehicles.

An analog signal from the image sensor 20 is processed by an analog signal processor 22 and applied to an analog to digital (A/D) converter 24. A timing generator 26 produces various clocking signals to select rows and pixels and synchronizes the operation of the analog signal processor 22 and the A/D converter 24. The image sensor stage 28 includes the image sensor 20, the analog signal processor 22, the A/D converter 24, and the timing generator 26. The components of the image sensor stage 28 can be separately fabricated integrated circuits, or they could be fabricated as a single integrated circuit as is commonly done with CMOS image sensors. The resulting stream of digital pixel values from the A/D converter 24 is stored in a memory 32 associated with the digital signal processor (DSP) 36.

The digital signal processor 36 is one of three processors or controllers in the illustrated embodiment, in addition to a system controller 50 and an exposure controller 40. Although this partitioning of camera functional control among multiple controllers and processors is typical, these controllers or processors are combined in various ways without affecting the functional operation of the camera and the application of the present invention. These controllers or processors can comprise one or more digital signal processor devices, microcontrollers, programmable logic devices, or other digital logic circuits. Although a combination of such controllers or processors has been described, it should be apparent that one controller or processor can be designated to perform all of the needed functions. All of these variations can perform the same function and fall within the scope of this invention, and the term “processing stage” will be used as needed to encompass all of this functionality within one phrase, for example, as in processing stage 38 in FIG. 1.

In the illustrated embodiment, the DSP 36 manipulates the digital image data in its memory 32 according to a software program permanently stored in program memory 54 and copied to the memory 32 for execution during image capture. The DSP 36 executes the software necessary for practicing image processing. The memory 32 includes of any type of random access memory, such as SDRAM. A bus 30 comprising a pathway for address and data signals connects the DSP 36 to its related memory 32, A/D converter 24 and other related devices.

The system controller 50 controls the overall operation of the camera based on a software program stored in the program memory 54, which can include Flash EEPROM or other nonvolatile memory. This memory can also be used to store image sensor calibration data, user setting selections and other data which must be preserved when the camera is turned off. The system controller 50 controls the sequence of image capture by directing the exposure controller 40 to operate the lens 12, ND filter 13, iris 14, and shutter 18 as previously described, directing the timing generator 26 to operate the image sensor 20 and associated elements, and directing the DSP 36 to process the captured image data. After an image is captured and processed, the final image file stored in memory 32 is transferred to a host computer via an interface 57, stored on a removable memory card 64 or other storage device, and displayed for the user on an image display 88.

A bus 52 includes a pathway for address, data and control signals, and connects the system controller 50 to the DSP 36, program memory 54, system memory 56, host interface 57, memory card interface 60 and other related devices. The host interface 57 provides a high speed connection to a personal computer (PC) or other host computer for transfer of image data for display, storage, manipulation or printing. This interface is an IEEE1394 or USB2.0 serial interface or any other suitable digital interface. The memory card 64 is typically a Compact Flash (CF) card inserted into a socket 62 and connected to the system controller 50 via a memory card interface 60. Other types of storage that are utilized include, for example, PC-Cards, MultiMedia Cards (MMC), or Secure Digital (SD) cards.

Processed images are copied to a display buffer in the system memory 56 and continuously read out via a video encoder 80 to produce a video signal. This signal is output directly from the camera for display on an external monitor, or processed by the display controller 82 and presented on an image display 88. This display is typically an active matrix color liquid crystal display (LCD), although other types of displays are used as well.

The user interface, including all or any combination of viewfinder display 70, exposure display 72, status display 76 and image display 88, and user inputs 74, is controlled by a combination of software programs executed on the exposure controller 40 and the system controller 50. User inputs 74 typically include some combination of buttons, rocker switches, joysticks, rotary dials or touchscreens. The exposure controller 40 operates light metering, exposure mode, autofocus and other exposure functions. The system controller 50 manages the graphical user interface (GUI) presented on one or more of the displays, for example, on the image display 88. The GUI typically includes menus for making various option selections and review modes for examining captured images.

The exposure controller 40 accepts user inputs selecting exposure mode, lens aperture, exposure time (shutter speed), and exposure index or ISO speed rating and directs the lens and shutter accordingly for subsequent captures. The brightness sensor 16 is employed to measure the brightness of the scene and provide an exposure meter function for the user to refer to when manually setting the ISO speed rating, aperture and shutter speed. In this case, as the user changes one or more settings, the light meter indicator presented on viewfinder display 70 tells the user to what degree the image will be over or underexposed. In an automatic exposure mode, the user changes one setting and the exposure controller 40 automatically alters another setting to maintain correct exposure. For example, for a given ISO speed rating when the user reduces the lens aperture, the exposure controller 40 automatically increases the exposure time to maintain the same overall exposure.

There are many variations of the disclosed embodiment of the camera, and although this description is with reference to a digital camera, it will be understood that the present invention applies for use with any type of image capture device.

The image sensor 20 shown in FIG. 1 typically includes a two-dimensional array of light sensitive pixels fabricated on a substrate that provide a way of converting incoming light at each pixel into an electrical signal that is measured. As the sensor is exposed to light, free charge carriers are generated and captured within the electronic structure at each pixel. Capturing these free charge carriers for some period of time and then measuring the number of charge carriers captured, or measuring the rate at which free charge carriers are generated can measure the light level at each pixel. In the former case, accumulated charge is shifted out of the array of pixels to a charge to voltage measurement circuit as in a charge coupled device (CCD), or the area close to each pixel can contain elements of a charge to voltage measurement circuit as in an active pixel sensor (APS or CMOS sensor).

The terms “wafer” and “substrate” are to be understood as including silicon-on-insulator (SOI) or silicon-on-sapphire (SOS) technology, doped and undoped semiconductors, epitaxial layers of silicon supported by a base semiconductor foundation, and other semiconductor structures. Furthermore, when reference is made to a “wafer” or “substrate” in the following description, previous process steps may have been utilized to form regions or junctions in or above the base semiconductor structure or foundation. In addition, the semiconductor need not be silicon-based, but could be based on silicon-germanium, germanium, or gallium arsenide.

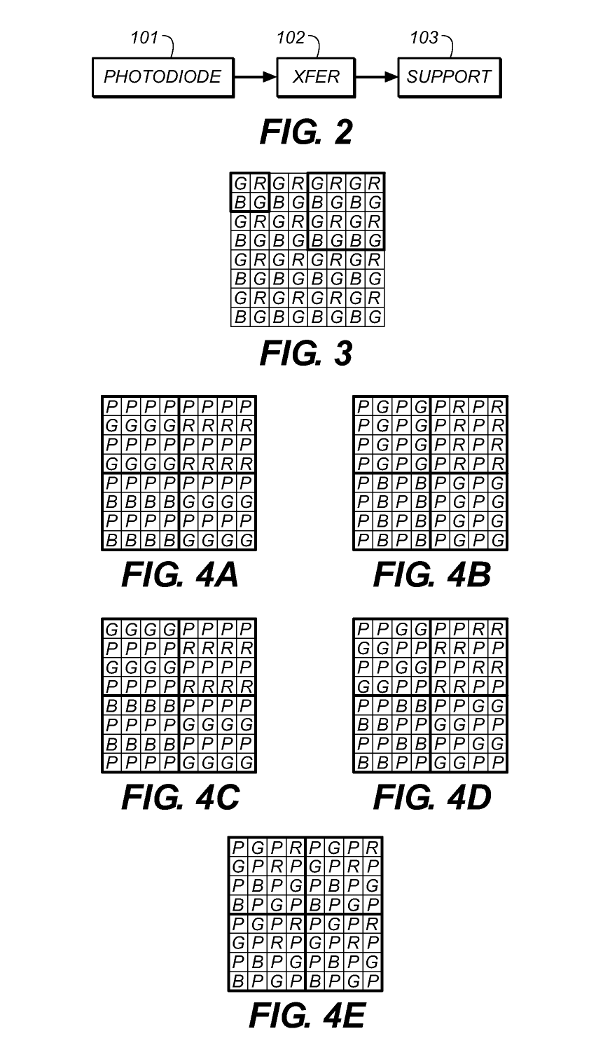

In the context of an image sensor, a pixel (a contraction of “picture element”) refers to a photosensitive element that includes a discrete light sensing area and charge shifting or charge measurement circuitry associated with the light sensing area. FIG. 2 conceptually illustrates portions of a pixel that includes a photodetector, such as a photodiode 101 for collecting a charge in response to incident light and a transfer mechanism 102 for transferring the charge from the photodetector to support circuitry 103.

In order to produce a color image, the array of pixels in an image sensor typically has a pattern of color filters placed over them. FIG. 3 illustrates a pattern of red, green, and blue color filters that is commonly used. This particular pattern is commonly known as a Bayer color filter array (CFA) after its inventor Bryce Bayer as disclosed in U.S. Pat. No. 3,971,065 (incorporated by reference herein). This pattern is effectively used in image sensors having a two-dimensional array of color pixels. As a result, each pixel has a particular color photoresponse that, in this case, is a predominant sensitivity to red, green or blue light. Another useful variety of color photoresponses is a predominant sensitivity to magenta, yellow, or cyan light. In each case, the particular color photoresponse has high sensitivity to certain portions of the visible spectrum, while simultaneously having low sensitivity to other portions of the visible spectrum.

An image captured using an image sensor having a two-dimensional array with the CFA of FIG. 3 has only one color value at each pixel. In order to produce a full color image, there are a number of techniques for inferring or interpolating the missing colors at each pixel. These CFA interpolation techniques are well known in the art, and reference is made to the following patents that are incorporated by reference: U.S. Pat. No. 5,506,619, U.S. Pat. No. 5,629,734, and U.S. Pat. No. 5,652,621.

To improve the overall sensitivity of an image sensor, pixels that include color filters can be intermixed with pixels that do not include color filters (panchromatic pixels). As used herein, a panchromatic photoresponse refers to a photoresponse having a wider spectral sensitivity than those spectral sensitivities represented in the selected set of color photoresponses. A panchromatic photosensitivity can have high sensitivity across the entire visible spectrum. The term panchromatic pixel will refer to a pixel having a panchromatic photoresponse. Although the panchromatic pixels generally have a wider spectral sensitivity than the set of color photoresponses, each panchromatic pixel can have an associated filter. Such filter is either a neutral density filter or a color filter.

When a pattern of color and panchromatic pixels is on the face of an image sensor, each pattern has a repeating unit that is a contiguous subarray of pixels that acts as a basic building block. FIGS. 4A-4E illustrate examples of a CFA that includes both color filter elements and panchromatic filter elements. By juxtaposing multiple copies of the repeating unit, the entire sensor pattern is produced. The juxtaposition of the multiple copies of repeating units are done in diagonal directions as well as in the horizontal and vertical directions.

The CFA pattern depicted in FIG. 4E is disclosed and described in U.S. Pat. Application Publication Nos. 2007/0024931 and 2007/0046807, which are both incorporated herein by reference. The color pixels in the pattern shown in FIG. 4E are bordered by four adjacent panchromatic filter elements. This allows the dielectric etch of the panchromatic layer to define the sidewalls of each color pixel.

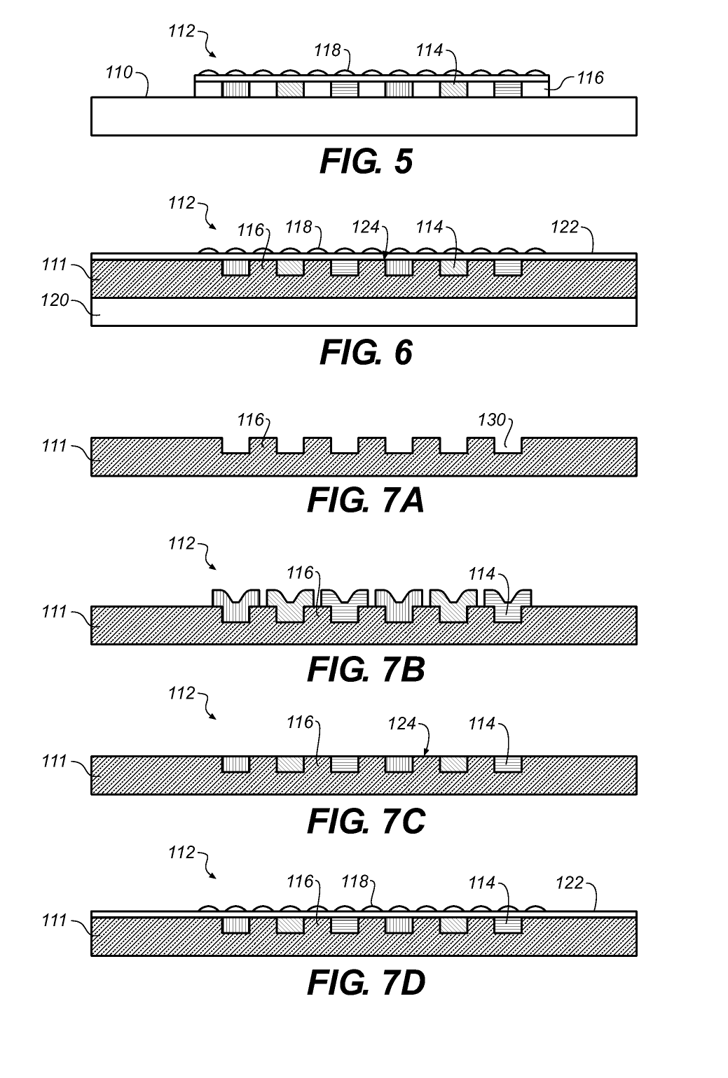

FIG. 5 illustrates portions of an image sensor having a CFA 112 that includes color filter elements 114 and panchromatic filter elements 116. The CFA 112 is stacked on top of, and extends above a substrate 110, with a microlens 118 situated over the CFA 112. Reducing the thickness of the optical stack and placing the lens 118 and color filter 112 closer to the detector enhances both quantum efficiency and angular quantum efficiency. Some attempts at such a reduction in stack height has been accomplished by placing the CFA 112, including the color and panchromatic elements in a trench that has been etched into the surface of the substrate 110. Both the color and panchromatic elements are deposited into the trench in an embodiment in accordance with the invention.

FIG. 6 illustrates an embodiment of an image sensor 20 in accordance with the present invention. A substrate 120 includes a pixel array and associated circuits for capturing an image. One or more transparent inorganic layers 111 is situated over the substrate 120, and a color filter array 112 has a plurality of panchromatic filter elements 116 formed by the transparent inorganic layer 111, as well as a plurality of color filter elements 114.

In the embodiment of FIG. 6, the layer 111 is etched to form openings only where the color elements 114 are placed. The panchromatic elements 116 are defined by the transparent layer 111, thus eliminating the need for adding additional panchromatic material for the CFA. As shown in FIG. 6, this also results in top surfaces of the panchromatic filter elements 116 and the color filter elements 114 being essentially planar with the top of the transparent layer 111. In other words, a common plane 124 is formed by the top surfaces of the panchromatic filter elements 116, the color filter elements 114 and the transparent layer 111.

In the embodiment illustrated in FIG. 6, a microlens 118 is formed over the CFA 112 with a spacing layer 122 between the CFA 112 and microlens 118.

FIGS. 7A-7D illustrate portions of a sequence for producing an embodiment of the CFA 112. FIG. 7A illustrates the transparent inorganic layer 111 with an array of openings or trenches 130 formed in the layer 111, for example, by a conventional etching process. As noted above, the inorganic layer 111 would be deposited over the substrate 120 as shown in FIG. 6.

Color filter elements 114 are deposited in the openings 130. In some embodiments, the color filter elements 114 are formed of an organic pigment, a color resist or acrylic material that is used as a light transmitting material. For example, the color filter elements 114 can include red, green and blue filter elements that are formed from resist or acrylic material of the respective color-filtering qualities. The color filter elements 114 can be deposited in the openings 130 by conventional deposition methods.

In some embodiments, the color filter elements 114 are deposited such that the colored material extends from the openings 130 as illustrated in FIG. 7B. The CFA 112 is then polished, for example using a CMP process, such that the top surfaces of the color filter elements 114 are essentially planar with the top surface of the transparent inorganic layer 111. Since the panchromatic filter elements 116 formed from the inorganic layer 111 are of a harder material than the color filter elements 114, a uniform color thickness is maintained.

FIG. 7C illustrates the common plane 124 created by the panchromatic filter elements 116 (which are formed by the transparent layer 111) and the color filter elements 114 after the CMP process.

In FIG. 7D, the spacing layer 122 has been deposited over the CFA 112, with a micro lens 118 situated over the spacer 122. As noted above, in some embodiments, the CFA 112 is polished prior to deposition of the spacing layer 122 and formation of the micro lens 118.

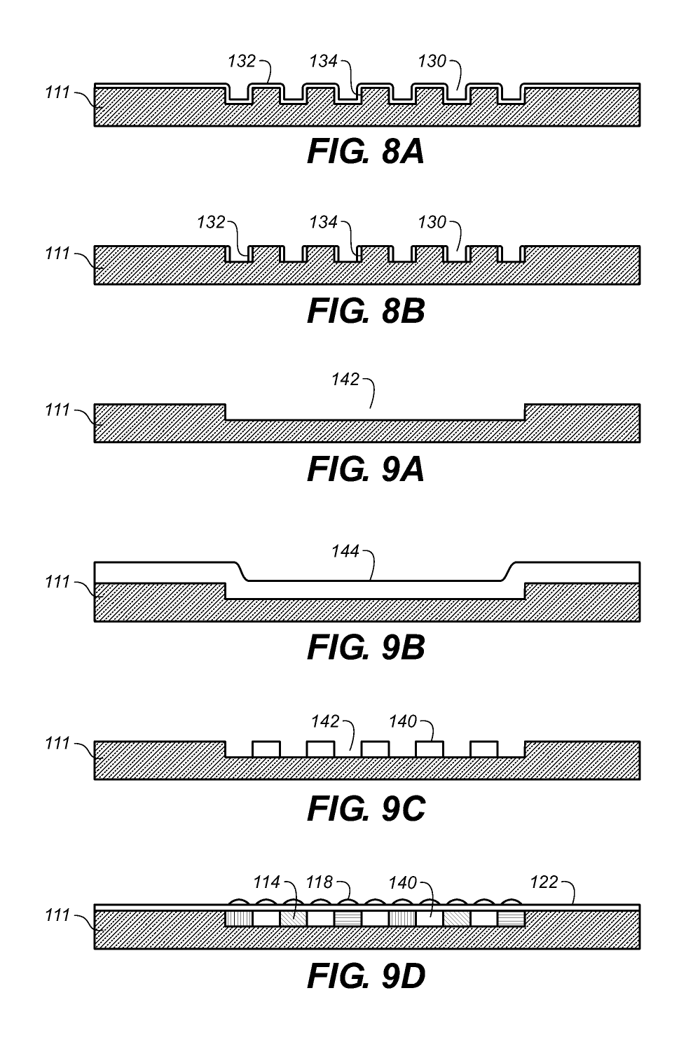

In some embodiments, a layer 132 of high index material such as silicon nitride or metal is deposited over the transparent inorganic layer 111, as illustrated in FIG. 8A, prior to deposition of the color filter elements. The high index material has a higher refractive index than the inorganic layer 111 in an embodiment in accordance with the invention. This layer 132 coats at least the sidewalls 134 of the openings. In some embodiments, the layer 132 is etched back as illustrated in FIG. 8B, so that only the sidewalls 134 are coated. Further, the layer 132 can be tuned to have anti-reflective properties.

FIGS. 9A-9D illustrate another embodiment of a CFA. In the embodiment illustrated in FIG. 9, the entire pillars 140 (FIG. 9C) separating the color elements 114 (FIG. 9D) are made of a high index material such as silicon nitride, which effectively allows the panchromatic elements to act as a light pipe and reduce panchromatic to color cross-talk.

In FIG. 9A, an opening 142 is formed in a transparent inorganic layer 111, for example, by a suitable etching process. FIG. 9B illustrates the layer 111 with a high index material 144 such as silicon nitride deposited over the layer 111. In FIG. 9C, the high index material 144 is etched to form the pillars 140. FIG. 9D illustrates the CFA with the color filter elements 114, the spacer layer 122 and micro lens 118.

Image sensors are generally classified as either frontside illuminated image sensors or backside illuminated image sensors. In a frontside illuminated sensor, light is projected from the lens 12, through the support circuitry 103 formed over the pixel array 120. With a backside illuminated sensor, exposed light is projected towards the backside surface of the substrate having the photosensitive elements. Backside illuminated sensors typically are produced using a silicon-on-insulator wafer having a buried oxide layer formed on one surface of the semiconductor substrate containing the pixel array 120. In some embodiments where the image sensor 20 is a backside illuminated sensor, the transparent inorganic layer 111 is this buried oxide layer adjacent the substrate.

The invention has been described in detail with particular reference to certain preferred embodiments thereof, but it will be understood that variations and modifications can be effected within the spirit and scope of the invention. Additionally, even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible.

For example, an image sensor can include a substrate; a pixel array of photosensitive elements disposed in the substrate; one or more transparent inorganic layers disposed on the substrate; a plurality of openings formed in the one or more transparent inorganic layers; and a color filter array including a plurality of color filter elements situated in the openings, and a plurality of panchromatic filter elements formed by the one or more transparent inorganic layers situated between the openings. A top surface of the color filter elements and a top surface of the one or more transparent inorganic layers situated between the openings can form a common plane. The image sensor can further include a microlens situated over the color filter array. The image sensor can further include a spacing layer situated between the color filter array and the microlens. A high index material having a higher refractive index than the one or more transparent inorganic layers can be disposed on at least the sidewalls of the openings. The high index material can include silicon nitride or metal. The color filter elements can be formed with any type of color filter elements, including, but not limited to, red, blue, green, cyan, magenta, yellow, and panchromatic filter elements. The image sensor can be disposed in an image capture device.

A method of forming an image sensor can include forming an array of openings in one or more transparent inorganic layers disposed on a substrate; depositing a plurality of color filter elements into the openings, wherein the remaining one or more transparent inorganic layers situated between the openings forms a plurality of panchromatic filter elements such that the color filter elements and the panchromatic filter elements form a color filter array having color filter elements and panchromatic filter elements. The method can further include forming a common plane by polishing the color filter array such that a top surface of the color filter elements and a top surface of the panchromatic filter elements are co-planar. The array of openings can be formed by etching an array of openings in the one or more transparent inorganic layers. A microlens can be formed over the color filter array. A spacing layer can be formed over the color filter array prior to forming the microlens over the color filter array. A layer of high index material can be formed over the transparent inorganic layer prior to depositing the plurality of color filter elements into the openings. The layer of high index material can be etched such that high index material is disposed only on the sidewalls of the openings prior to depositing the plurality of color filter elements into the openings.

### PARTS LIST

10 light
11 imaging stage
12 lens
13 ND filter block
14 iris block
16 brightness sensor block
18 shutter block
20 image sensor
22 analog signal processor
24 analog to digital (A/D) converter
26 timing generator
28 image sensor stage
30 bus
32 memory
36 digital signal processor (DSP)
38 processing stage
40 exposure controller
50 system controller
52 bus
54 program memory
56 system memory
57 host interface
60 memory card interface
62 socket
64 memory card
70 viewfinder display
72 exposure display
74 user inputs
76 status display
80 video encoder
82 display controller
88 image display
101 photodiode
102 transfer mechanism
103 support circuitry
110 substrate
111 transparent layer
112 CFA
114 color filter elements
116 panchromatic filter elements
118 microlens
120 pixel array
122 spacing layer
124 common plane
130 openings
132 high index coating
134 sidewalls of openings
140 high index pillars
142 opening
144 high index material

1. An image sensor, comprising:
a substrate;
a pixel array of photosensitive elements disposed in the substrate;
one or more transparent inorganic layers disposed on the substrate;
a plurality of openings formed in the one or more transparent inorganic layers; and
a color filter array including a plurality of color filter elements situated in the openings, and a plurality of panchromatic filter elements formed by the one or more transparent inorganic layers situated between the openings.

2. The image of claim 1, wherein a top surface of the color filter elements and a top surface of the one or more transparent inorganic layers situated between the openings form a common plane.

3. The image sensor of claim 1, wherein the color filter elements include red, blue, and green filter elements.

4. The image sensor of claim 1, further comprising a microlens situated over the color filter array.

5. The image sensor of claim 4, further comprising a spacing layer situated between the color filter array and the microlens.

6. The image sensor of claim 1, wherein a high index material having a higher refractive index than the one or more transparent inorganic layers is disposed on at least the sidewalls of the openings.

7. The image sensor of claim 6, wherein the high index material comprises silicon nitride.

8. The image sensor of claim 6, wherein the high index material comprises a metal.

9. A method of forming an image sensor, comprising:
forming an array of openings in one or more transparent inorganic layers disposed on a substrate;
depositing a plurality of color filter elements into the openings, wherein the remaining one or more transparent inorganic layers situated between the openings forms a plurality of panchromatic filter elements such that the color filter elements and the panchromatic filter elements form a color filter array having color filter elements and panchromatic filter elements.

10. The method of claim 9, wherein forming an array of openings comprises etching an array of openings in the one or more transparent inorganic layers.

11. The method of claim 9, further comprising depositing a layer of high index material over the transparent inorganic layer prior to depositing the plurality of color filter elements into the openings.

12. The method of claim 9, further comprising forming a microlens over the color filter array.

13. The method of claim 12, further comprising forming a spacing layer over the color filter array prior to forming the microlens over the color filter array.

14. The method of claim 9, further comprising forming a common plane by polishing the color filter array such that a top surface of the color filter elements and a top surface of the panchromatic filter elements are co-planar.

15. The method of claim 11, further comprising etching the layer of high index material such that high index material is disposed only on the sidewalls of the openings prior to depositing the plurality of color filter elements into the openings.

16. An image capture device, comprising:
a pixel array of photosensitive elements disposed in the substrate;
one or more transparent inorganic layers disposed on the substrate;
a plurality of openings formed in the one or more transparent inorganic layers; and
a color filter array including a plurality of color filter elements situated in the openings, and a plurality of panchromatic filter elements formed by the one or more transparent inorganic layers situated between the openings.

17. The image capture device of claim 16, a top surface of the color filter elements and a top surface of the one or more transparent inorganic layers situated between the openings form a common plane.

18. The image capture device of claim 16, wherein the color filter elements include red, blue, and green filter elements.

19. The image capture device of claim 16, further comprising a microlens situated over the color filter array.

20. The image capture device of claim 19, further comprising a spacing layer situated between the color filter array and the microlens.

21. The image capture device of claim 16, wherein a high index material having a higher refractive index than the one or more transparent inorganic layers is disposed on at least the sidewalls of the openings.

22. The image sensor of claim 21, wherein the high index material comprises silicon nitride.

23. The image sensor of claim 21, wherein the high index material comprises a metal.
